(19) United States
(12) Patent Application Publication
(10) Pub. No.: US 2011/0229251 A1
(43) Pub. Date: Sep. 22, 2011

(54) JOINT STRUCTURE WITH A STABLE UNLOCKED STATE FOR A FOLDABLE PLAYPEN

(75) Inventor: Chuan-Ming Yeh, Chuayi City (TW)

(73) Assignee: LERADO (ZHONG SHAN) INDUSTRIAL CO., LTD, Guang Dong Province (CN)

(21) Appl. No.: 13/051,955

(22) Filed: Mar. 18, 2011

(30) Foreign Application Priority Data
Mar. 19, 2010 (CN) 201020148217.4

(51) Int. Cl. F16C 11/10

(52) U.S. Cl. 403/81

(57) ABSTRACT

A joint structure with a stable unlocked state for a foldable playpen, comprising a pair of upper rails, a rigid shroud, a pair of lock pins, a pair of spring biased pin-carriers, and a release actuator. The pair of upper rails each have a necked portion and a pushing element; the rigid shroud is pivotally connected between the pair of upper rails; the pair of spring biased pin-carriers is installed within the rigid shroud for carrying the pair of lock pins to engage with the necked portion, thereby locking the pair of upper rails in a use position and to leave the necked portion to release the pair of upper rails from the use position. The pair of spring biased pin-carriers are featuring with a side extension flap for abutting against the pushing element, and an associating short arm for keeping the pair of spring biased pin-carriers to rotate in an opposite directions simultaneously. The release actuator is operatively mounted on outside of the rigid shroud for driving the pair of spring biased pin-carriers to drive the pair of lock pins to disengage from the necked portion thereby releasing the pair of upper rails from the use position to rotate to a folded position.

### CROSS-REFERENCE TO RELATED APPLICATIONS

This non-provisional application claims priority under 35 U.S.C. §119(a) on Patent Application No. 201020148217.4 filed in People's Republic of China on Mar. 19, 2010, the entire contents of which are hereby incorporated by reference.

### FIELD OF THE INVENTION

The present invention relates generally to a joint structure for a foldable playpen, especially to a joint structure that includes a pushing element for preventing a pair of lock pins from returning to its locked position after a release actuator thereof being manipulated.

### BACKGROUND OF THE INVENTION

The deploying and folding of a foldable playpen, are necessarily controlled by locking and unlocking the joints thereof. For example, U.S. Pat. No. 6,250,837 discloses a rail joint that can be manipulated to lock a pair of upper rails of play yard for deploying in a use position, and unlock the pair of upper rails by pressing an actuator.

The rail joint of U.S. Pat. No. 6,250,837 pivotally connects a pair of rail members each having a notch latch, and has a pair of hinge arms each having a finger for removably engaging with the notch latch for locking the pair of rail member in a use position, and an actuator having a elliptical-shaped shaft for drive the hinge arms away from each other, so as to unlock the pair of upper rails by rotation. The lower end of the hinge arms formed with a pair of gear teeth for meshing with each other, this could force the hinge arms to rotate in opposite direction simultaneously.

However, sometime, when unlocking the rail members, the gaps inside the rail joint may cause only one finger of the hinge arm disengaged from the notch latch, and another one may still engaged with the notch latch; at this moment, the finger of the hinge arm may become permanently deformed or be broken, if the user suddenly impose a large force onto the rail members.

### SUMMARY OF THE INVENTION

To avoid such a problem, the present invention provides a joint structure with a stable unlocked state for a foldable playpen, comprising a pair of upper rails, a rigid shroud, a pair of lock pins, a pair of spring biased pin-carriers, and a release actuator. The pair of upper rails each have a necked portion and a pushing element; the rigid shroud is pivotally connected between the pair of upper rails; the pair of spring biased pin-carriers is installed within the rigid shroud for carrying the pair of lock pins to engage with the necked portion, thereby locking the pair of upper rails in a use position and to leave the necked portion to release the pair of upper rails from the use position. The pair of spring biased pin-carriers are featuring with a side extension flap for abutting against the pushing element, and an associating short arm for keeping the pair of spring biased pin-carriers to rotate in an opposite directions simultaneously. The release actuator is operatively mounted on outside of the rigid shroud for driving the pair of spring biased pin-carriers to drive the pair of lock pins to disengage from the necked portion thereby releasing the pair of upper rails from the use position to rotate to a folded position.

### BRIEF DESCRIPTION OF THE DRAWINGS

The accompanying drawings, which are included to provide a further understanding of the invention are incorporated in and constitute a part of this specification, illustrate embodiments of the invention and together with the description serve to explain the principles of the invention. In the drawings:

FIG. 1 is a perspective view showing a foldable playpen having a plurality of upper rails controlled by manipulating the joint structure according to the present invention.

FIG. 2 is a exploded perspective view for showing the joint structure according to the present invention.

FIG. 3 is a perspective view schematically showing a release actuator of the joint structure according to the present invention.

FIG. 4 is a side view schematically showing the connection relation of the joint structure according to the present invention.

FIG. 5 is a schematic view showing the operation of the joint structure according to the present invention, wherein the upper rails are locked in a use position.

FIG. 6 is a schematic view showing the operation of the joint structure according to the present invention, wherein the upper rails are unlocked and rotating to a folded position.

FIG. 7 is a schematic view showing the operation of the joint structure according to the present invention, wherein the upper rails are rotated to a folded position.

FIG. 8 is a schematic view showing an alternative embodiment of the joint structure according to the present invention.

FIG. 9 is a schematic view showing an alternative embodiment of the joint structure having a sign tab for showing if the unlock state is reached.

FIG. 10 is a schematic view showing the playpen equipped with the joint structure according to the present invention can be folded into a compact configuration.

### DETAILED DESCRIPTION OF THE PREFERRED EMBODIMENTS

Reference will now be made in detail to the preferred embodiments of the present invention; examples of which are illustrated in the accompanying drawings.

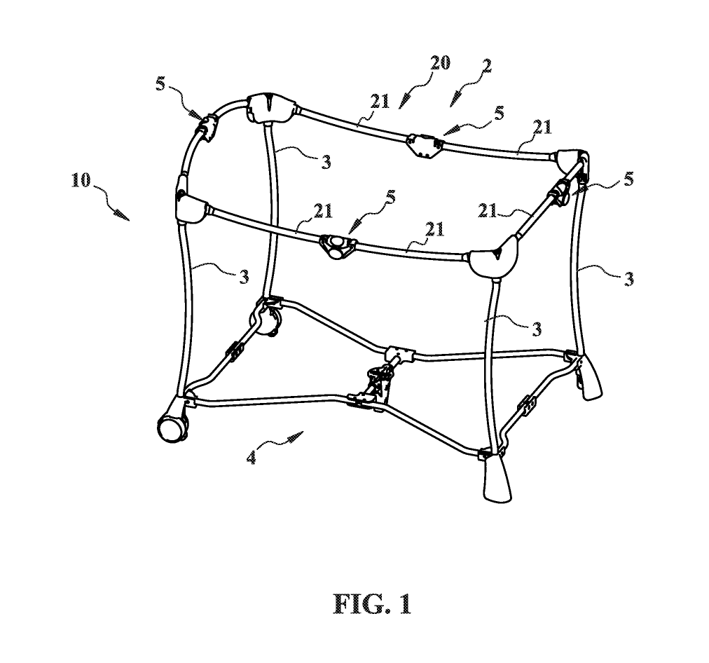

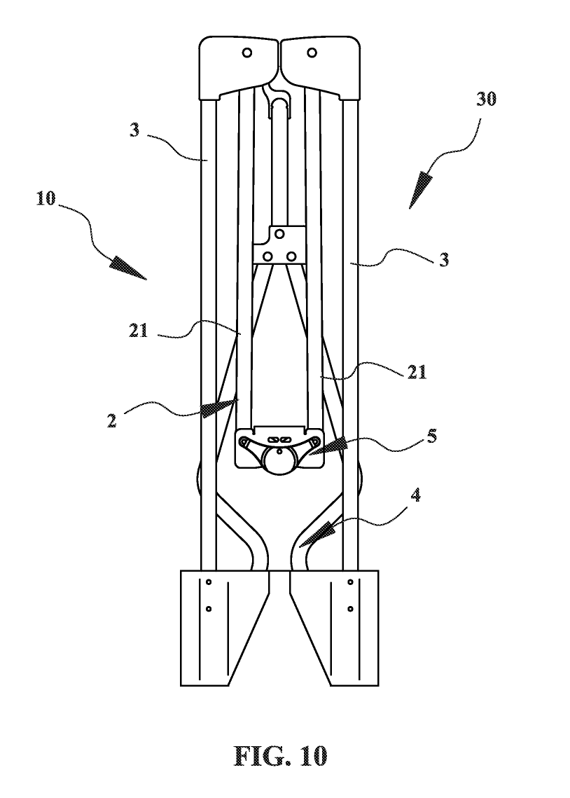

Referring to FIGS. 1 and 10, a foldable playpen 10 normally includes at least an upper rail assembly 2, a lower rail assembly 4 and a plurality of corner strut 3. The upper rail assembly 2 includes a plurality of upper rails 21 which are pivotally connected with each other by the joint structures 5 and controlled by the joint structure 5 according to the present invention.

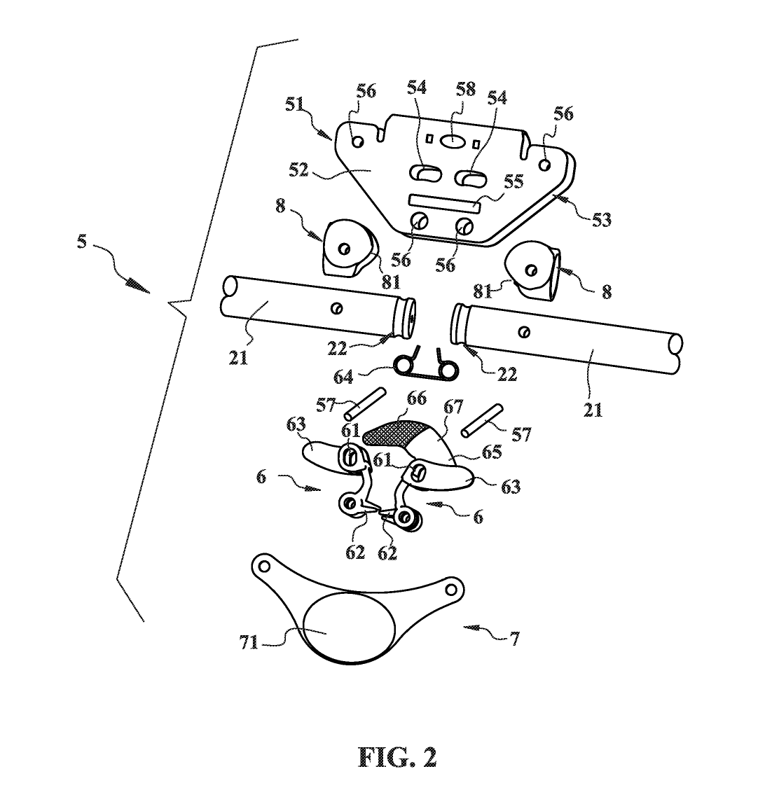

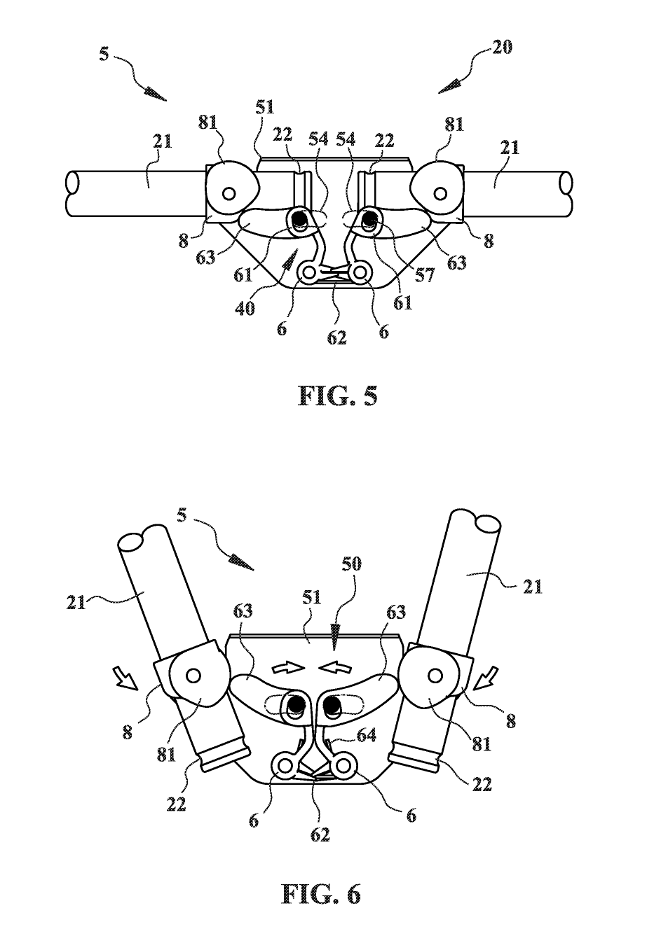

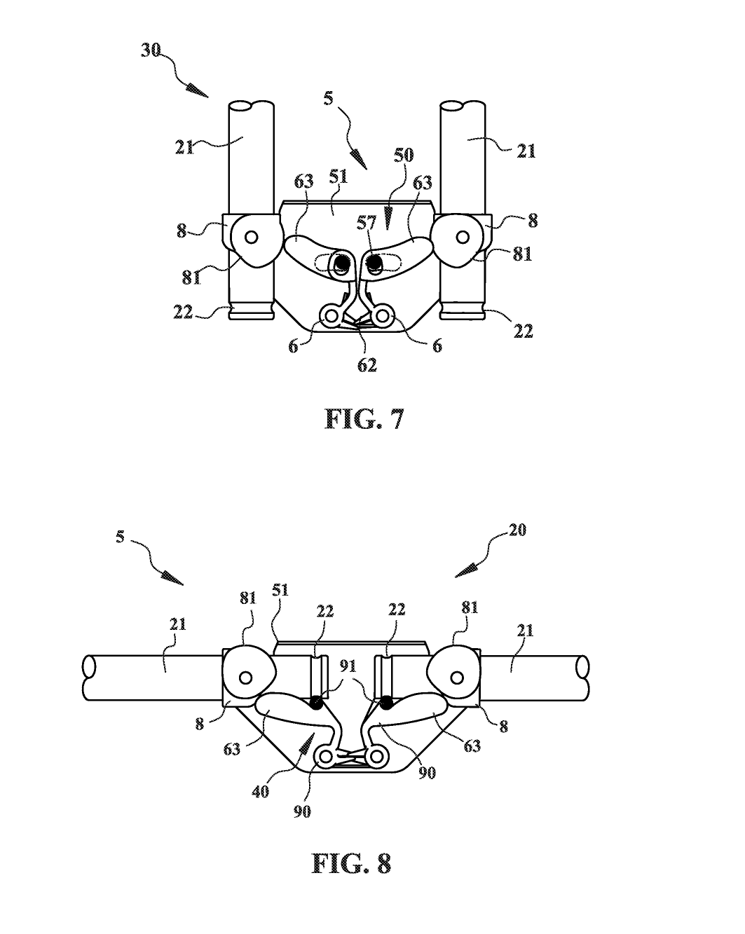

Referring to FIGS. 2 to 7, an embodiment of the joint structure 5 with a stable unlocked state 50 for a foldable playpen 10 according to the present invention, comprises at least a pair of upper rails 21, a rigid shroud 51, a pair of lock pins 57, a pair of spring biased pin-carriers 6, and a release actuator 7.

The pair of upper rails 21 each has a necked portion 22 and a pushing element 8. The pair of upper rails 21 can be locked in a use position 20 by the pair of lock pins 57 and be released into a folded position 30 by pressing the release actuator 7.

The rigid shroud 51 includes two parallel side walls 52 and formed a receiving space 53 therebetween. The side walls 52 each has a plurality of pivot points 56 for pivoting the pair of upper rails 21, a pair of pushing elements 8, and the pair of spring biased pin-carriers 6 within the receiving space 53.

Preferably, the side walls 52 may further be formed with a pair of guiding slots 54 for guiding moving of the pair of lock pins 57. The pair of lock pins 57 each has two ends penetrate the pair of guiding slots 54, and a middle portion held in two pin holes 61 formed on the pair of spring biased pin-carriers 6.

The pair of lock pins 57 each has a locked position 40 to engage within the necked portion 22, and an unlocked position 50 while the joint structure 5 is released into an unlocked state.

When the spring biased pin-carriers 6 are driven by the release actuator 7 and rotated to close to each other, the pin holes 61 would carry the pair of lock pins 57 moving along the pair of guiding slots 54, so as to disengage from the necked portions 22 of the pair of upper rails 21.

As shown in FIG. 8, the pair of spring biased pin-carriers 91 may be embodied alternatively without the pin holes and the spring biased pin-carriers 91 may be formed integrally with the lock pins 90.

The pair of spring biased pin-carriers 6 are installed within the rigid shroud 51 and biased by a spring 64 to rotate close to each other thereby carrying the pair of lock pins 57 to engage with the necked portion 22 in the locked position 40 automatically, thereby locking the pair of upper rails 21 into a use position 20.

The pair of spring biased pin-carriers 6 can be driven by manipulating the release actuator 7 to depart from each other, so as to carry the pair of lock pins 57 to disengage from the necked portion 22 thereby releasing the pair of upper rails 21 from the use position 20.

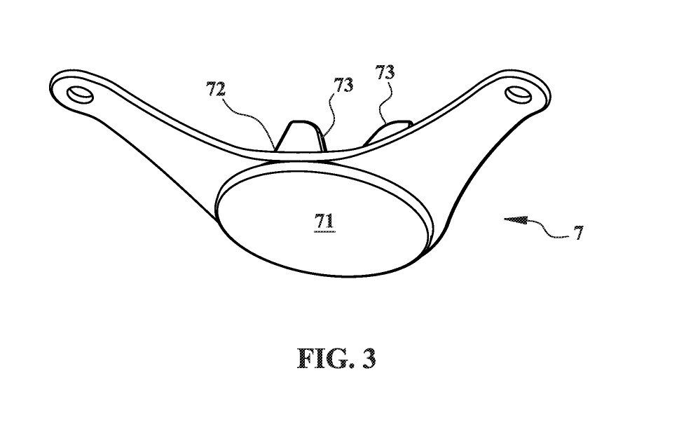

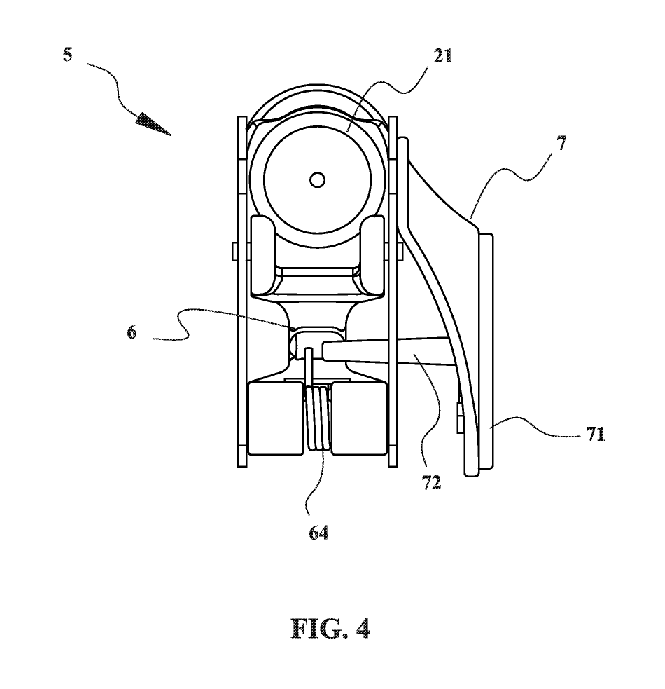

The release actuator 7 is operatively mounted on outside of the rigid shroud 51 for driving the pair of spring biased pin-carriers 6 to drive the pair of lock pins 57 to disengage from the necked portion 22 thereby releasing the pair of upper rails 21 from the use position 20 to rotate to a folded position 30. Referring to FIGS. 3 and 4, the release actuator 7 has a button portion 71 for pressing by user and a push arm 72 extending into the receiving space 53 through a slot 55 formed on one of the side walls 52. The push arm 72 is preferably formed with a V-like edge 73 for slidably abutting the pair of spring biased pin-carriers 6; when the button portion 71 is pushed toward or pressed against the side wall 52, the V-like edge 73 would drive the pair of spring biased pin-carriers 6 to rotate close to each other, thereby carrying the pair of lock pins 57 to disengage from the necked portion 22.

The pair of spring biased pin-carriers 6 are featuring with having a side extension flap 63 for abutting against the pushing element 8, and an associating short arm 62 for associating and keeping the pair of spring biased pin-carriers 6 to rotate in an opposite directions simultaneously. When the lock pins 57 disengaged from the necked portion 22, the pushing element 8 would follows the upper rails 21 to rotate and push the side extension flap 63, this can force the pair of spring biased pin-carriers 6 to rotate, thereby preventing the lock pins 57 from returning to the necked portion 22. By this way, the joint structure 5 can be kept in a stable unlocked state.

The associating short arms 62 are formed on the lower end of the pair of spring biased pin-carriers 6 and associated with each other, thereby keeping the pair of spring biased pin-carriers 6 to rotate in an opposite directions simultaneously.

Preferably, the pushing element 8 may be formed in a cam-like configuration 81 for abutting and pushing the side extension flap 63 by rotating the pair of upper rails 21. When rotate the pair of upper rails 21, the cam-like configuration 81 would push the side extension flap 63 and the pair of spring biased pin-carriers 6 to rotate, this would help to prevent the lock pins 57 from returning to the necked portion 22 and thereby keeping the joint structure in a stable unlocked state.

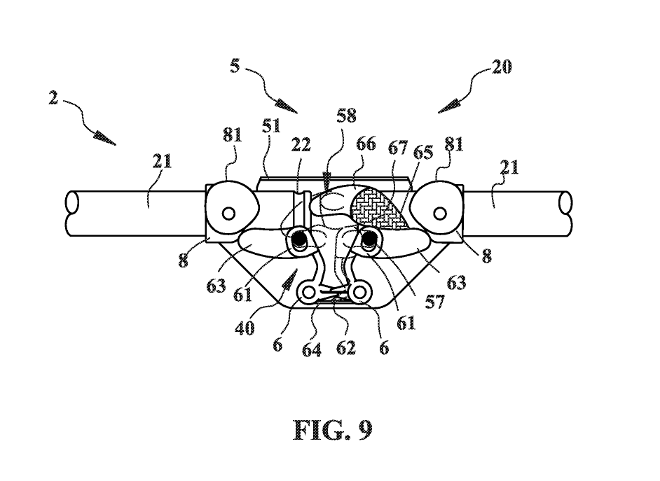

Referring to FIGS. 2 and 9, the rigid shroud 51 may further be formed with a window 58, and one of the pair of spring biased pin-carriers 6 may connected a sign tab 65 for showing the unlocked state of the joint structure 5 with a color through the window 58. Preferably, the sign tab 65 may be colored with a first color area 66 and a second color area 67, and reveals the second color area 67 from the window 58 while the joint structure 5 is in a stable unlocked state.

While particular embodiments of the invention have been described, those skilled in the art will recognize that many modifications are possible that will achieve the same goals by substantially the same system, device or method, and where those systems, devices or methods still fall within the true spirit and scope of the invention disclosed.

What is claimed is:

1. A joint structure with a stable unlocked state for a foldable playpen, comprising:
a pair of upper rails, each having a necked portion, and connected with a pushing element;
a rigid shroud, pivotally connected between the pair of upper rails;
a pair of lock pins;
a pair of spring biased pin-carriers, each pivoted within the rigid shroud for carrying the pair of lock pins to engage with the necked portion thereby locking the pair of upper rails in a use position, and to leave the necked portion to release the pair of upper rails from the use position; wherein the pair of spring biased pin-carriers each formed with a side extension flap for abutting against one of the pushing element, and an associating short arm for keeping the pair of spring biased pin-carriers to rotate in an opposite directions simultaneously; and
a release actuator, operatively mounted on outside of the rigid shroud for driving the pair of spring biased pin-carriers to drive the pair of lock pins to disengage from the necked portion thereby releasing the pair of upper rails from the use position so as to rotate to a folded position.

2. The joint structure with a stable unlocked state for a foldable playpen according to claim 1, wherein each of the spring biased pin-carriers is formed integrally with one of the lock pins.

3. The joint structure with a stable unlocked state for a foldable playpen according to claim 1, wherein the rigid shroud has two side walls, and each side wall has a pair of guiding slots for guiding the pair of lock pins.

4. The joint structure with a stable unlocked state for a foldable playpen according to claim 3, wherein the pair of lock pins connect with the pair of spring biased pin-carriers and each has two ends penetrate the pair of guiding slots, the pair of lock pins is driven by the rotation of the spring biased pin-carriers and guided by the pair of guiding slots, to engage to and disengage from the necked portions of the pair of upper rails simultaneously.

5. The joint structure with a stable unlocked state for a foldable playpen according to claim 1, wherein the side extension flap is abutted and pushed by the pushing element; when rotating the pair of upper rails, the pushing element pushes the side extension flap and the pair of spring biased pin-carriers to rotate, so as to prevent the lock pins from returning to the necked portion and thereby keeping the joint structure in a stable unlocked state.

6. The joint structure with a stable unlocked state for a foldable playpen according to claim 1, wherein the pushing element are formed in a cam-like configuration for abutting and pushing the side extension flap by rotating the pair of upper rails; when rotating the pair of upper rails, the cam-like configuration pushes the side extension flap and the pair of spring biased pin-carriers to rotate, so as to prevent the lock pins from returning to the necked portion and thereby keeping the joint structure in a stable unlocked state.

7. The joint structure with a stable unlocked state for a foldable playpen according to claim 1, wherein the associating short arms formed on each of the pair of spring biased pin-carriers are associated with each other, thereby keeping the pair of spring biased pin-carriers to rotate in an opposite directions simultaneously.

8. The joint structure with a stable unlocked state for a foldable playpen according to claim 1, wherein the pair of lock pins is disengaged from the necked portion by rotating the pair of spring biased pin-carriers close to each other.

9. The joint structure with a stable unlocked state for a foldable playpen according to claim 1, wherein one of the pair of upper rails is rotated to drive the pair of spring biased pin-carriers, and then the pair of spring biased pin-carriers drive another upper rail to rotate simultaneously in opposite direction.

10. The joint structure with a stable unlocked state for a foldable playpen according to claim 1, wherein the rigid shroud is formed with a window, and one of the pair of spring biased pin-carriers has a sign tab for showing the unlocked state of the joint structure with color through the window.

11. The joint structure with a stable unlocked state for a foldable playpen according to claim 10, wherein the sign tab has a first color area and a second color area.
